(19) United States
(12) Patent Application Publication
(10) Pub. No.: US 2009/0067916 A1
(43) Pub. Date: Mar. 12, 2009

(54) PULSE GENERATOR WITH A SEALING DEVICE

(76) Inventors: Andrea Busse, Unterkimach (DE); Horst Plankenhorn, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/282,923

(22) PCT Filed: Dec. 7, 2007
(86) PCT No.: PCT/EP2007/063491

§ 371 Date: Sep. 15, 2008

(30) Foreign Application Priority Data
Dec. 27, 2006 (DE) 10 2006 061 644.8

(51) Int. Cl. F16D 9/06; H01R 13/213

(52) U.S. Cl. 403/2; 439/314

(57) ABSTRACT

A pulse generator has a sealing device, wherein the cylindrically shaped pulse generator has at one end a thread for screwing it in a threaded bore of a wall element until contact is made with a flange region on the wall element. At the other end, the pulse generator has a plug connector for electrically contacting a sensor element arranged with the pulse generator. The pulse generator further has first spanner surfaces in the center region. The pulse generator is surrounded in the region of the first spanner surfaces by a sleeve-like sealing cap, which is secured in the position thereof surrounding the region of the first spanner surfaces when the threaded bore of the wall element is screwed into the pulse generator. The sealing cap has second spanner surfaces at the outside thereof and is connected to the pulse generator via a target breaking point.

### CROSS-REFERENCE TO RELATED APPLICATIONS

This application is a U.S. national stage application of International Application No. PCT/EP2007/063491 filed Dec. 7, 2007, which designates the United States of America, and claims priority to German application number 10 2006 061 644.8 filed Dec. 27, 2006, the contents of which are hereby incorporated by reference in their entirety.

### TECHNICAL FIELD

The invention relates to a pulse generator having a sealing device, wherein the pulse generator in the shape of a cylinder comprises at one of its ends a thread for screwing into a threaded bore in a wall element until it abuts with a flange face against the wall element, at its other end a plug-type connector for making electrical contact with a sensor element which is arranged in the pulse generator, and having in its central region first wrench faces or a fastening surface, having a sleeve-like sealing hood which surrounds the pulse generator in the region of the wrench faces and which is secured in its position surrounding the region of the wrench faces, when the pulse generator is screwed into the threaded bore in the wall element.

### BACKGROUND

In such a pulse generator it is known to screw the pulse generator into the threaded bore in the wall element and then to fit the sealing hood onto the pulse generator, and in its installed position it latches with the pulse generator here by means of latching elements.

Such an embodiment requires a high degree of expenditure on mounting since after the pulse generator has been mounted the sealing hood still has to be mounted.

### SUMMARY

A pulse generator of the type mentioned at the beginning can be provided which is of simple design and requires a low degree of expenditure on mounting.

According to an embodiment, a pulse generator may comprise a sealing device, wherein the pulse generator is in the shape of a cylinder and comprises at one of its ends a thread for screwing into a threaded bore in a wall element until it abuts with a flange face against the wall element, at its other end a plug-type connector for making electrical contact with a sensor element which is arranged in the pulse generator, in its central region first wrench faces or a fastening surface, and a sleeve-like sealing hood which surrounds the pulse generator in the region of the first wrench faces and which is secured in its position surrounding the region of the first wrench faces, when the pulse generator is screwed into the threaded bore in the wall element, wherein the sealing hood has second wrench faces or a second fastening surface on its outer side and is connected to the pulse generator via a predetermined break point or via a coupling, and wherein the coupling is closed in the screwing in direction of rotation of the pulse generator into the threaded bore and opened in the unscrewing direction of rotation.

According to a further embodiment, the sealing hood may have one or more latching projections which project into corresponding recesses in the pulse generator at a radial distance from the longitudinal axis of the thread of the pulse generator and can be torn off when a specific lateral force is exceeded. According to a further embodiment, the coupling may be a clamping pawl which is arranged between the sealing hood and pulse generator, by means of which the sealing hood is coupled to the pulse generator in the screwing in direction of rotation of the sealing hood, and the sealing hood is decoupled from the pulse generator in the unscrewing direction of rotation of the sealing hood. According to a further embodiment, the coupling can be a ratchet which is arranged between the sealing hood and the pulse generator, and by means of which the sealing hood is coupled to the pulse generator in the screwing in direction of rotation of the sealing hood, and the sealing hood is decoupled from the pulse generator in the unscrewing direction of rotation of the sealing hood. According to a further embodiment, the sensor element can be a Hall element. According to a further embodiment, the pulse generator may have a sensor sleeve which is provided with the first wrench faces and the thread, and into whose coaxial through-opening a sensor housing is inserted in a freely rotatable and axially secured fashion, wherein the sensor housing comprises the sensor element, the flange face and the plug-type connector. According to a further embodiment, the sensor sleeve can be completely surrounded by the sealing hood. According to a further embodiment, the sensor housing can be secured axially in the through-opening of the sensor sleeve by means of one or more securing elements. According to a further embodiment, the securing element or elements can be securing rings which are inserted into an annular groove which is formed so as to run around radially on the lateral face of the sensor housing, and project into a second annular groove which is formed so as to run around radially on the inner wall of the through-opening. According to a further embodiment, the through-opening can be a stepped bore at whose transition from the large step to the small step the sensor housing which is embodied in a correspondingly stepped fashion is supported axially by a shoulder. According to a further embodiment, the sensor housing may comprise a radially protruding element, in particular a flange, which abuts axially against the front-side end of the sealing hood which faces the plug-type connector. According to a further embodiment, the pulse generator may be embodied at its end comprising the plug-type connector with a bayonet connection structure onto which a union nut of a plug which can be connected to the plug-type connector can be screwed.

### BRIEF DESCRIPTION OF THE DRAWINGS

An exemplary embodiment of the invention is illustrated in the drawing and will be explained in more detail in the text which follows. In said drawing:

FIG. 1 is a front view of a pulse generator having a sealing device in section,

FIG. 2 is a side view of the pulse generator having a sealing device according to FIG. 1 in section,

FIG. 3 is a plan view of the pulse generator having a sealing device according to FIG. 1,

FIG. 4 is a view of the pulse generator from below having a sealing device according to FIG. 1,

FIG. 5 is a perspective sectional view of the pulse generator having a sealing device according to FIG. 1, and

FIG. 6 is a perspective view of the pulse generator having a sealing device according to FIG. 1.

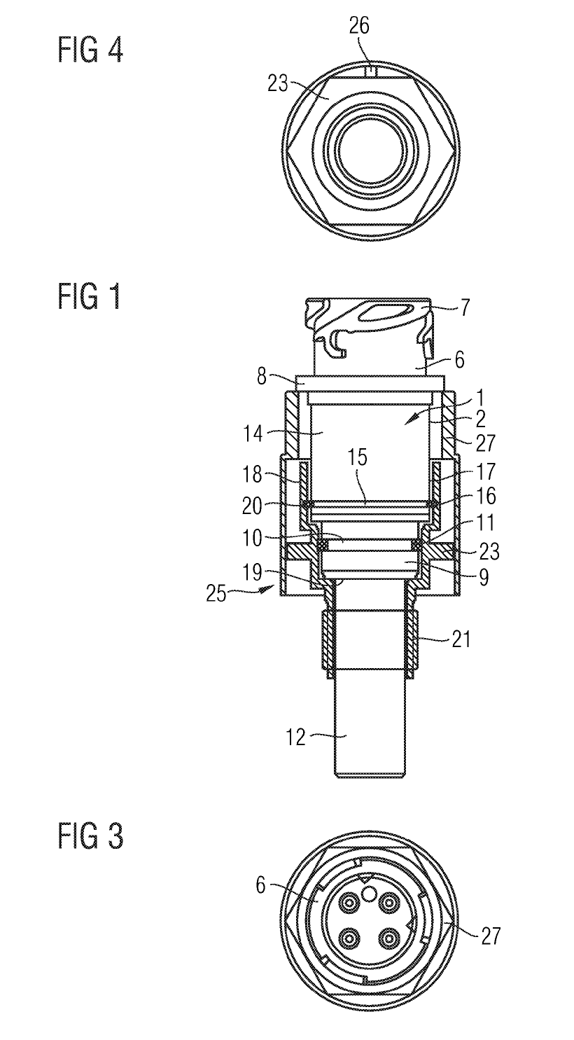

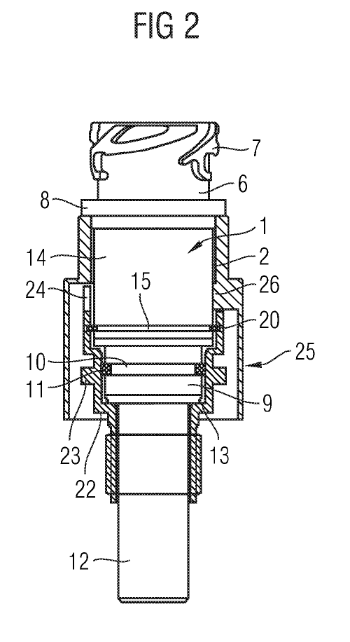

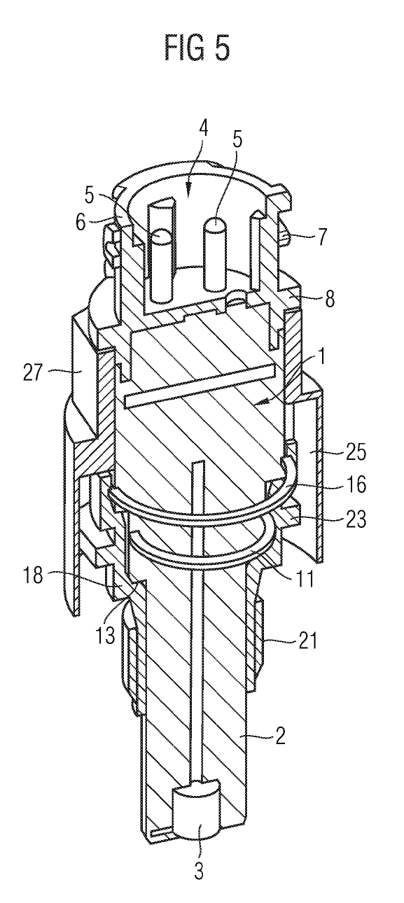

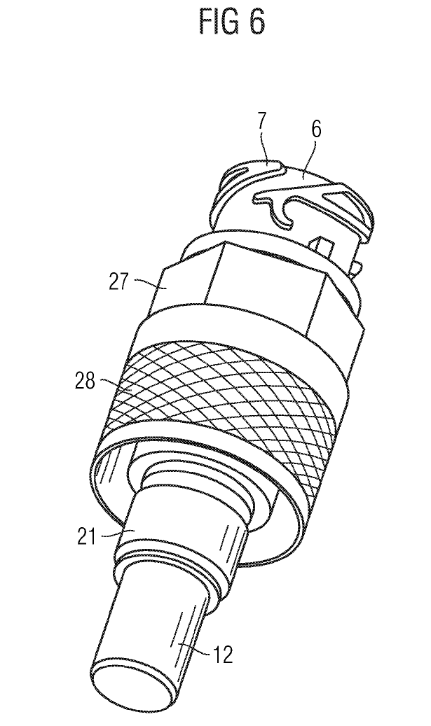

### DETAILED DESCRIPTION

According to various embodiments, the sealing hood may have second wrench faces or a fastening surface on its outer side and may be connected to the pulse generator via a predetermined break point or via a coupling, wherein the coupling is closed in the screwing in direction of rotation of the pulse generator into the threaded bore and opened in the unscrewing direction of rotation.

As a result of this embodiment, the pulse generator can already be premounted with the sealing hood as an assembly in order then to be screwed into the wall element.

For this purpose, a tool is used which engages on the second wrench faces. The sealing hood is turned in the screwing in direction of rotation by means of the tool. Since the sealing hood is connected to the pulse generator via the predetermined break point or the coupling, the pulse generator here is screwed by its thread into the threaded bore of the wall element. The predetermined break point is dimensioned here in such a way that the torque which is necessary for this purpose can be reliably applied.

When the pulse generator abuts with its flange face against the wall element, the torque exceeds the force which can be transmitted by the predetermined break point with the result that the connection through the predetermined break point fractures.

The pulse generator can no longer be released from the threaded bore by turning the sealing hood in the unscrewing direction since the sealing hood and the pulse generator are no longer connected to one another in a rotationally fixed fashion.

This is also the case when the coupling is rotated since said coupling transmits a torque from the sealing hood to the pulse generator only in the screwing in direction of rotation but not in the unscrewing direction of rotation.

If the pulse generator is to be unscrewed again, this is possible only by removing the sealing hood through destruction. In this way, the first wrench face of the pulse generator is exposed and can be used to rotate the pulse generator in the unscrewing direction. Unauthorized removal or manipulation of the pulse generator is therefore prevented by the sealing hood and/or is apparent from damage to the sealing hood.

Such pulse generators are used for acquiring measured values in vehicles and are, for example, attached to the housing of a vehicle transmission in such a way that the probe of the pulse generator with which said generator projects through the wall of the transmission housing is assigned directly to a gearwheel of the transmission or to a specific timing disk.

Because of the documentary character of the acquired and transmitted measured values, manipulation has to be made more difficult or prevented, and this is done by means of the sealing hood.

In order to embody the predetermined break point in a simple way, the sealing hood can have one or more latching projections which project into corresponding recesses in the pulse generator at a radial distance from the longitudinal axis of the thread of the pulse generator and can be torn off when a specific lateral force is exceeded.

For the purpose of simple axial plug-in mounting when assembling the pulse generator and sealing hood to form one structural unit, the recesses may be open axially in one direction, and a latching projection of the sealing hood can be introduced axially through this opening.

Of course, it is also correspondingly possible to arrange the latching projections on the pulse generator and the recesses on the sealing hood.

The coupling can be a clamping pawl which is arranged between the sealing hood and the pulse generator, by means of which the sealing hood is coupled to the pulse generator in the screwing in direction of rotation of the sealing hood, and the sealing hood is decoupled from the pulse generator in the unscrewing direction of rotation of the sealing hood. Another embodiment consists in the fact that the coupling is a ratchet which is arranged between the sealing hood and the pulse generator, and by means of which the sealing hood is coupled to the pulse generator in the screwing in direction of rotation of the sealing hood, and the sealing hood is decoupled from the pulse generator in the unscrewing direction of rotation of the sealing hood.

The sensor element may be preferably a Hall element.

If the pulse generator has a sensor sleeve which is provided with the first wrench faces and the thread, and into whose coaxial through-opening a sensor housing is inserted in a freely rotatable and axially secured fashion, in which case the sensor housing comprises the sensor element, the flange face and the plug-type connector, rotation of the pulse generator at the plug-type connector which projects out of the sealing hood does not cause the pulse generator to be released from the wall element since the sensor housing can be rotated freely in the sensor sleeve which is protected by the sealing hood.

In this context, the sensor sleeve may be preferably completely surrounded by the sealing hood.

The sensor housing can be secured axially here in the through-opening of the sensor sleeve by means of one or more securing elements.

This can be achieved using simple means in that the securing element or elements are securing rings which are inserted into an annular groove which is formed so as to run around radially on the lateral face of the sensor housing, and project into a second annular groove which is formed so as to run around radially on the inner wall of the through-opening.

In order to bring about axial securement in the one axial direction, the through-opening can be a stepped bore at whose transition from the large step to the small step the sensor housing which is embodied in a correspondingly stepped fashion is supported axially by a shoulder.

The possibility of removing the sealing hood axially without destruction is easily prevented by virtue of the fact that the sensor housing comprises a radially protruding element, in particular a flange, which abuts axially against the front-side end of the sealing hood which faces the plug-type connector.

In order to securely attach a plug which is provided with a connecting cable on the plug-type connector, the pulse generator is embodied at its end comprising the plug-type connector with a bayonet connection structure onto which a union nut of a plug which can be connected to the plug-type connector can be screwed.

The pulse generator 1 which is illustrated in the figures is composed of a rotationally symmetrical, enclosed sensor housing 2 in one end region of which a sensor element 3, such as for example a Hall element, is arranged.

Lines (not illustrated) lead from the sensor element 3 in the interior of the sensor housing 2 to the second end region, located opposite, of the sensor housing 2 which is embodied as a plug-type connector 4 with two axially protruding contact pins 5 to which the lines lead.

The contact pins 5 which project out of the sensor housing 2 are surrounded at a distance by a sleeve part 6 of the sensor housing 2 on whose outer lateral face a bayonet structure 7 for screwing on a union nut (not illustrated) of a plug which can be connected to the plug-type connector is formed.

At the second end region, the sensor housing 2 has a radially protruding, circumferential flange 8.

The sensor housing 1 is embodied in a stepped fashion such that it decreases from its largest outer diameter at its second end region in two cylindrical steps in its outer diameter toward the first end region.

The central step is embodied on its cylindrical lateral face with a groove 10 which runs around radially and in which an elastic sealing ring 11 which protrudes out of the groove 10 is arranged.

The radial transition from the central step 9 to the step 12 with the smallest diameter forms an annular shoulder 13. An annular groove 15 which runs around radially and into which a radially sprung securing ring 16 is inserted is formed on the cylindrical lateral face of the step 14 with the largest diameter of the sensor housing 2.

The sensor housing 2 is inserted axially into a through-opening 17 in a sensor sleeve 18 of the pulse generator 1 so as to be freely rotatable about its longitudinal axis, with the through-opening being embodied as a stepped bore 17 in a way which corresponds to the outer contour of the sensor housing 2.

In this context, the shoulder 13 of the sensor housing 2 is supported axially on the radial transition from the central step to the small step of the stepped bore 17.

In this installation position, the annular groove 15 has lying radially opposite it a second annular groove 20 which is formed on the inner wall of the central step of the stepped bore 17 so as to run around radially, with the effect that the securing ring 16 projects radially into the second annular groove 20 and secures the sensor housing 2 axially in the sensor sleeve 18.

The sensor housing 2 projects with its first end region and with its second end region out of the sensor sleeve 18.

On the lateral outer face which runs radially around the small step of the sensor sleeve 18, a thread 21 is formed with which the pulse generator 1 can be screwed into a threaded bore in a wall element (not illustrated) until the sensor sleeve 18 abuts with a radial flange face 22, formed at the transition from the small step to the middle step, against the wall element.

In the region of the middle step, the sensor sleeve 18 has first wrench faces 23 which are embodied as a hexagon on their outer side. A radially continuous recess 24, which opens outward in the axial direction at the free end of the large step, is formed in the sleeve wall, at the free end region of the large step in the sensor sleeve 18.

Apart from the region of the thread 21 and of the sleeve part 6, the pulse generator 1 is surrounded by a sleeve-like sealing hood 25 which can be composed of a plastic or some other material which can easily be destroyed.

The sealing hood 25 is guided coaxially with respect to the pulse generator 1 by means of the first wrench faces 23 which bear against the inner contour of the sealing hood 25.

A latching projection 26, arranged in the interior of the sealing hood 25 and extending axially, of the sealing hood 25 projects into the recess 24 and forms a rotationally fixed connection of the sealing hood 25 to the sensor sleeve 18, by means of which connection a torque up to a certain magnitude can be transmitted.

The end of the sealing hood 25 which faces the plug-type connector 4 abuts axially against the flange 8.

On its outer side, the sealing hood 25 is formed with second wrench faces 27 which are also embodied as a hexagon.

In order to install the pulse generator 1 with the sealing hood 25, the latter is screwed as a premountable assembly with the thread 21 of the pulse generator 1 into a threaded bore in a wall element until the flange face 22 abuts against the wall element in the screwing in direction of rotation.

This is done by means of a tool which acts on the second wrench faces 27. This requires a torque which is below the maximum torque which can be transmitted by the latching projection 26.

When the flange face 22 abuts, the torque rises above the maximum torque which can be transmitted by the latching protection 26, in which case the latching projection 26 breaks away from the sealing hood 25.

If the pulse generator 1 is then to be unscrewed again, this is no longer possible by means of a tool which acts on the sealing hood 25 since the sealing hood 25 is then rotationally decoupled from the pulse generator 1.

The pulse generator 1 can then be unscrewed only after destroying and removing the blocking hood 25 by means of a tool which acts on the first wrench faces 23 of the pulse generator 1. However, in this context, a safety band 28, which surrounds the cylindrical lateral face of the sealing hood, is also destroyed.

1. A pulse generator comprising a sealing device, wherein the pulse generator is in the shape of a cylinder and comprises at one of its ends a thread for screwing into a threaded bore in a wall element until it abuts with a flange face against the wall element, at its other end a plug-type connector for making electrical contact with a sensor element which is arranged in the pulse generator, in its central region first wrench faces, and a sleeve-like sealing hood which surrounds the pulse generator in the region of the first wrench faces and which is secured in its position surrounding the region of the first wrench faces, when the pulse generator is screwed into the threaded bore in the wall element, wherein the sealing hood has second wrench faces on its outer side and is connected to the pulse generator via a predetermined break point or via a coupling, and wherein the coupling is closed in the screwing in direction of rotation of the pulse generator into the threaded bore and opened in the unscrewing direction of rotation.

2. The pulse generator according to claim 1, wherein the sealing hood has one or more latching projections which project into corresponding recesses in the pulse generator at a radial distance from the longitudinal axis of the thread of the pulse generator and can be torn off when a specific lateral force is exceeded.

3. The pulse generator according to claim 1, wherein the coupling is a clamping pawl which is arranged between the sealing hood and pulse generator, by means of which the sealing hood is coupled to the pulse generator in the screwing in direction of rotation of the sealing hood, and the sealing hood is decoupled from the pulse generator in the unscrewing direction of rotation of the sealing hood.

4. The pulse generator according to claim 1, wherein the coupling is a ratchet which is arranged between the sealing hood and the pulse generator, and by means of which the sealing hood is coupled to the pulse generator in the screwing in direction of rotation of the sealing hood, and the sealing hood is decoupled from the pulse generator in the unscrewing direction of rotation of the sealing hood.

5. The pulse generator according to claim 1, wherein the sensor element is a Hall element.

6. The pulse generator according to claim 1, wherein the pulse generator has a sensor sleeve which is provided with the first wrench faces and the thread, and into whose coaxial through-opening a sensor housing is inserted in a freely rotatable and axially secured fashion, wherein the sensor housing comprises the sensor element, the flange face and the plug-type connector.

7. The pulse generator according to claim 6, wherein the sensor sleeve is completely surrounded by the sealing hood.

8. The pulse generator according to claim 6, wherein the sensor housing is secured axially in the through-opening of the sensor sleeve by means of one or more securing elements.

9. The pulse generator according to claim 8, wherein the securing element or elements are securing rings which are inserted into an annular groove which is formed so as to run around radially on the lateral face of the sensor housing, and project into a second annular groove which is formed so as to run around radially on the inner wall of the through-opening.

10. The pulse generator according to claim 7, wherein the through-opening is a stepped bore at whose transition from the large step to the small step the sensor housing which is embodied in a correspondingly stepped fashion is supported axially by a shoulder.

11. The pulse generator according to claim 7, wherein the sensor housing comprises a radially protruding element, in particular a flange, which abuts axially against the front-side end of the sealing hood which faces the plug-type connector.

12. The pulse generator according to claim 1, wherein the pulse generator is embodied at its end comprising the plug-type connector with a bayonet connection structure onto which a union nut of a plug which can be connected to the plug-type connector can be screwed.

13. A pulse generator having the shape of a cylinder and comprising
a sealing device,
at one of its ends a thread for screwing into a threaded bore in a wall element until it abuts with a flange face against the wall element,
at its other end a plug-type connector,
a sensor element coupled with said plug-type connector,
in its central region first fastening surface, and
a sleeve-like sealing hood which surrounds the pulse generator in the region of the first fastening surface and which is secured in its position surrounding the region of the first fastening surface, when the pulse generator is screwed into the threaded bore in the wall element,
wherein the sealing hood has second fastening surface on its outer side and is connected to the pulse generator via a predetermined break point or via a coupling, and
wherein the coupling is closed in the screwing in direction of rotation of the pulse generator into the threaded bore and opened in the unscrewing direction of rotation.

14. The pulse generator according to claim 13, wherein the sealing hood has one or more latching projections which project into corresponding recesses in the pulse generator at a radial distance from the longitudinal axis of the thread of the pulse generator and can be torn off when a specific lateral force is exceeded.

15. The pulse generator according to claim 13, wherein the coupling is a clamping pawl which is arranged between the sealing hood and pulse generator, by means of which the sealing hood is coupled to the pulse generator in the screwing in direction of rotation of the sealing hood, and the sealing hood is decoupled from the pulse generator in the unscrewing direction of rotation of the sealing hood.

16. The pulse generator according to claim 13, wherein the coupling is a ratchet which is arranged between the sealing hood and the pulse generator, and by means of which the sealing hood is coupled to the pulse generator in the screwing in direction of rotation of the sealing hood, and the sealing hood is decoupled from the pulse generator in the unscrewing direction of rotation of the sealing hood.

17. The pulse generator according to claim 13, wherein the sensor element is a Hall element.

18. The pulse generator according to claim 13, wherein the pulse generator has a sensor sleeve which is provided with the first fastening surface and the thread, and into whose coaxial through-opening a sensor housing is inserted in a freely rotatable and axially secured fashion, wherein the sensor housing comprises the sensor element, the flange face and the plug-type connector.

19. The pulse generator according to claim 18, wherein the sensor sleeve is completely surrounded by the sealing hood.

20. The pulse generator according to claim 18, wherein the sensor housing is secured axially in the through-opening of the sensor sleeve by means of one or more securing elements.
